(19) United States
(12) Patent Application Publication
(10) Pub. No.: US 2025/0162202 A1
(43) Pub. Date: May 22, 2025

(54) PUNCTURE EQUIPMENT AND METHOD FOR PUNCTURING FIBER PREPREG MATERIAL

(71) Applicant: ADVANCED INTERNATIONAL MULTITECH CO., LTD., Kaohsiung City (TW)

(72) Inventor: Wen-Hsien LEE, Kaohsiung City (TW)

(21) Appl. No.: 18/745,056

(22) Filed: Jun. 17, 2024

(30) Foreign Application Priority Data
Nov. 20, 2023 (TW) 112144767

(51) Int. Cl. B29B 13/00

(52) U.S. Cl. CPC B29B 13/00

(57) ABSTRACT

A puncture equipment for puncturing a fiber prepreg material includes a feeding roller set, a tension-controlling roller set, a puncture apparatus, and a roll-wrapping apparatus. The feeding roller set is adapted to deliver the fiber prepreg material along a feeding direction. The tension-controlling roller set is located downstream of the feeding roller set, and adapted to impart tension to the fiber prepreg material and to continuously deliver the fiber prepreg material along the feeding direction. The puncture apparatus is located downstream of the tension-controlling roller set, and includes a needle-carrying plate, a base plate, and a plurality of needles that are detachably disposed on the needle-carrying plate. The roll-wrapping apparatus is located downstream of the puncture apparatus and adapted to roll wrap the fiber prepreg material. A method for puncturing a fiber prepreg material is also provided.

### CROSS-REFERENCE TO RELATED APPLICATION

This application claims priority to Taiwanese Invention patent Application No. 112144767, filed on Nov. 20, 2023, the entire disclosure of which is incorporated by reference herein.

### FIELD

The disclosure relates to a puncture equipment, and more particularly to a puncture equipment for puncturing a fiber prepreg material. The disclosure also relates to a method for puncturing a fiber prepreg material.

### BACKGROUND

A prepreg material is made by impregnating a fiber material with resin. It may form into a desired three-dimensional shape by different techniques, such as by lamination thereof, or wrapping a complex mandrel with the prepreg material, followed by a thermoforming process and so forth, so as to obtain a composite product that is lightweight and has high strength. The prepreg material, after being produced by impregnating the fiber material with the resin, may be rolled into a roll and packaged for storage. Next, they are delivered downstream for further processing, e.g., the lamination, the rolling, the wrapping or the thermoforming process, as mentioned above. Since the composite product usually has a complex structure, some undesirable situations may arise during the process. For instance, the prepreg material may show a lack of ductility or poor wrapping quality, or may have resin accumulated therein. In addition, entrapped air voids may be present during the process due to air accumulation. Therefore, the present invention aims to make the prepreg material more adaptable for a product with a complex shape, and meanwhile solve the problem of the entrapped air voids, which may require the prepreg material to be reprocessed.

### SUMMARY

Therefore, an object of the disclosure is to provide a puncture equipment for puncturing a fiber prepreg material, and a method for puncturing a fiber prepreg material that can alleviate at least one of the drawbacks of the prior art.

According to a first aspect of the disclosure, the puncture equipment includes a feeding roller set, a tension-controlling roller set, a puncture apparatus, and a roll-wrapping apparatus. The feeding roller set is adapted to deliver the fiber prepreg material along a feeding direction. The tension-controlling roller set is located downstream of the feeding roller set, and adapted to impart tension to the fiber prepreg material and to continuously deliver the fiber prepreg material along the feeding direction. The puncture apparatus is located downstream of the tension-controlling roller set, and includes a needle-carrying plate, a base plate that is oppositely located to the need-carrying plate relative to the fiber prepreg material, and a plurality of needles that are detachably disposed on the needle-carrying plate. The needle-carrying plate is capable of moving toward the base plate. The needles have a number less than 6225, and any two adjacent ones of the needles are spaced apart by a distance ranging from 15 millimeters to 1000 millimeters. The roll-wrapping apparatus is located downstream of the puncture apparatus and adapted to roll wrap the fiber prepreg material.

According to a second aspect of the disclosure, the method includes:
delivering the fiber prepreg material along a feeding direction and imparting tension thereto; and
puncturing the fiber prepreg material, so as to form a plurality of perforations in a region of the fiber prepreg material, the perforations in the region of the fiber prepreg material having a number less than 6225, the region of the fiber prepreg material having long fibers and short fibers that are in a number ratio of 65.2 to 34.8, a fiber length between any two adjacent ones of the perforations in the region of the fiber prepreg material ranging from 15 millimeters to 1000 millimeters.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating an embodiment of a puncture equipment for puncturing a fiber prepreg material according to the disclosure.

FIG. 2 is a side view illustrating a puncture apparatus of the puncture equipment for puncturing the fiber prepreg material according to the disclosure.

FIG. 3 is a bottom view illustrating a needle-carrying plate of the puncture apparatus of the puncture equipment for puncturing the fiber prepreg material according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

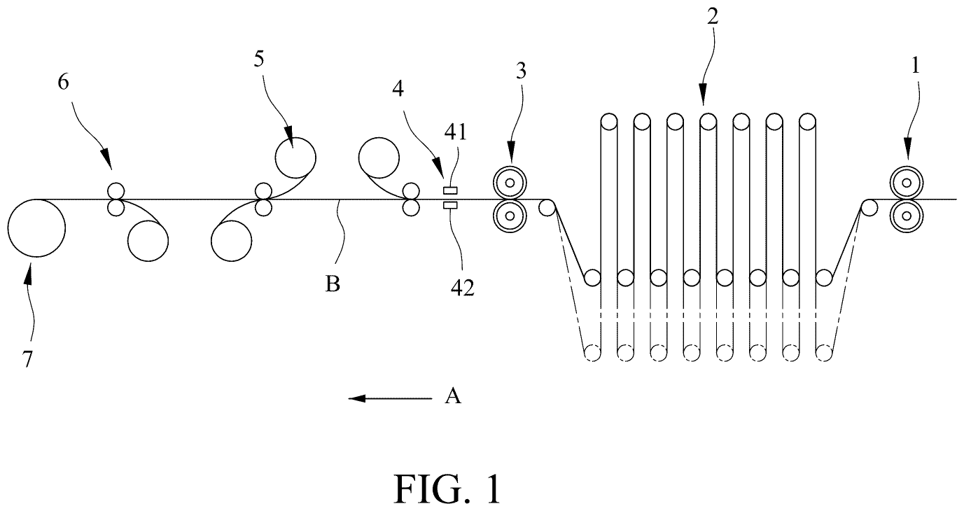

Referring to FIG. 1, an embodiment of a puncture equipment for puncturing a fiber prepreg material (B) according to the disclosure includes a feeding roller set 1 which is adapted to deliver the fiber prepreg material (B) along a feeding direction (A), a tension-controlling roller set 2 which is located downstream of the feeding roller set 1 and adapted to impart tension to the fiber prepreg material (B) and to continuously deliver the fiber prepreg material (B) along the feeding direction (A), a driving roller set 3 which is located downstream of the tension-controlling roller set 2 and adapted to assist delivery of the fiber prepreg material (B) along the feeding direction (A), a puncture apparatus 4 which is located downstream of the driving roller set 3, a first coating apparatus 5 which is located downstream of the puncture apparatus 4 and adapted to coat a film on the fiber prepreg material (B), a second coating apparatus 6 which is located downstream of the first coating apparatus 5 and adapted to coat a release paper on the fiber prepreg material (B), and a roll-wrapping apparatus 7 which is located downstream of the second coating apparatus 6 and adapted to roll wrap the fiber prepreg material (B).

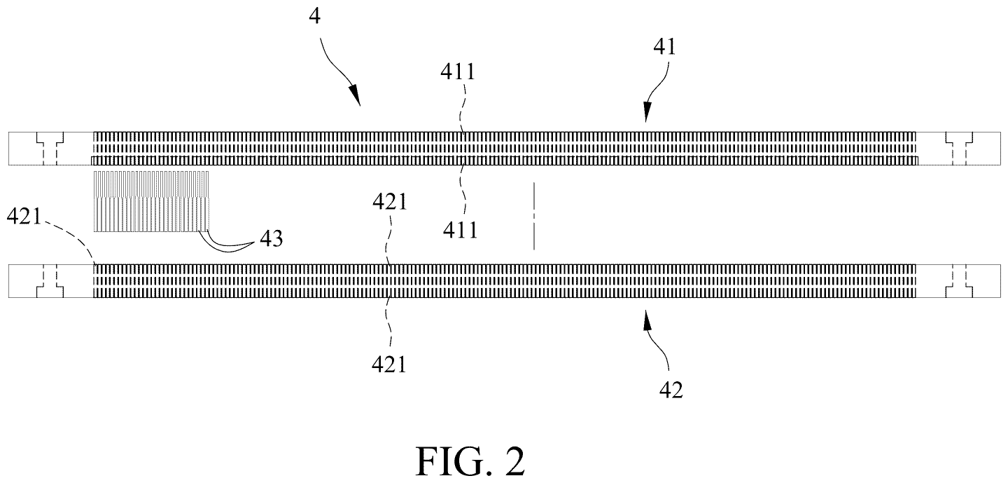

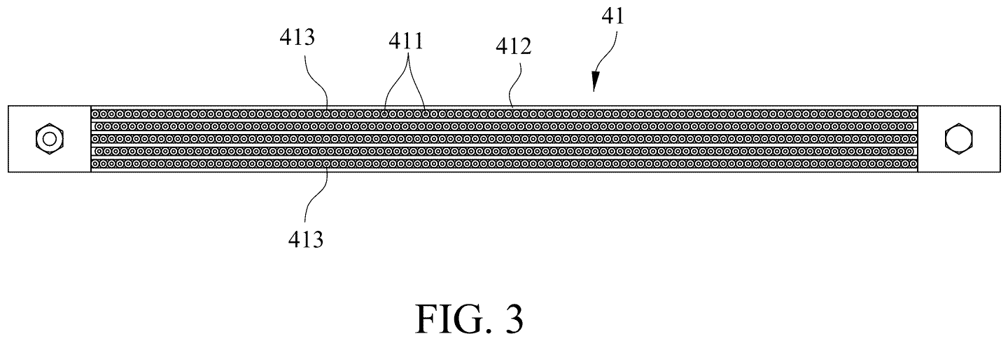

Referring to FIGS. 1 to 3, the puncture apparatus 4 includes a needle-carrying plate 41, a base plate 42 that is oppositely located to the needle-carrying plate 41 relative to the fiber prepreg material (B), and a plurality of needles 43 that are detachably disposed on the needle-carrying plate 41 (shown in FIG. 2). The needle-carrying plate 41 may be controlled to move toward the base plate 42, and includes a plate body 412 having a plurality of first holes 411, and a plurality of needle seats 413 disposed on the plate body 412. Each of the needle seats 413 is registered with a respective one of the first holes 411. In certain embodiments, the first holes 411 may be through holes. In addition, the base plate 42 has a plurality of second holes 421 which are respectively registered with the needle seats 413 of the needle-carrying plate 41. In certain embodiments, the second holes 421 may be through holes. The needles 43 are respectively inserted into the first holes 411 and held by the needle seats 413. Moreover, the needles 43 have a number less than 6225, and any two adjacent ones of the needles 43 are spaced apart by a distance ranging from 15 millimeters to 1000 millimeters. It should be noted that the needles 43 may be flat-head type needles as shown in FIG. 2, and in a situation where the needles 43 are the flat-head type needles, a metal stopper (not shown) may be secured on top of the plate body 412 after insertion of the needles 43 into the needle seats 413, so as to prevent the needles 43 from being pushed out. The needles 43 may be spring-loaded needles (not shown) so that the needles 43 may be quickly pulled out with the assistance of springs. Moreover, the needles 43 may also be L-shape hook needles (not shown), and in a situation where the needles 43 are the L-shape hook needles, a fastener (not shown) may be secured on the top of the plate body 412 of the needle-carrying plate 41 for fixing the needles 43 thereon.

The disclosure also provides a method for puncturing the fiber prepreg material (B). First, the fiber prepreg material (B) is delivered along the feeding direction (A) by the feeding roller set 1, and subsequently delivered along the feeding direction (A) by the tension-controlling roller set 2, which also imparts tension to the fiber prepreg material (B) in a controlled manner. Thereafter, the fiber prepreg material (B) having received the tension is continuously delivered along the feeding direction (A) by the driving roller set 3 and moves to a position between the needle-carrying plate 41 and the base plate 42, and then the needle-carrying plate 41 moves toward and away from the base plate 42 so that the needles 43 puncture the fiber prepreg material (B), so as to form a plurality of perforations in a region of the fiber prepreg material (B). An area of the region is equivalent to a surface area of the needle-carrying plate 41 which is utilized to press onto the fiber prepreg material (B) upon puncturing thereof, so that the perforations in the region of the fiber prepreg material (B) have the number less than 6225, and that a fiber length between any two adjacent ones of the perforations in the region of the fiber prepreg material (B) ranges from 15 millimeters to 1000 millimeters. In addition, the region of the fiber prepreg material (B) has long fibers and short fibers that are in a number ratio of 65.2 to 34.8. Specifically, the short fibers are those fibers that, after being punctured, have a length of less than 50% of a length of a mandrel (e.g., a diameter of the mandrel), which is a tool for wrapping, or have a length ranging from 15 millimeters to 1000 millimeters. Additionally, long fibers on the fiber prepreg material (B) are those fibers that, after being punctured, have a length of greater than or equal to 50% of the length of the mandrel, or have a length of greater than 1000 millimeters. In some embodiments, in each unit surface area of the fiber prepreg material (B), a ratio of a number of the long fibers to a number of the short fibers is 65.2:34.8. Thus, the strength of the fiber prepreg material (B) may be ensured while its ductility is increased. After passing the puncture apparatus 4, the fiber prepreg material (B) is to be coated with a film (commonly known as PE film) by the first coating apparatus 5 upon arrival thereat, and subsequently to be coated with a release paper by the second coating apparatus 6 as it arrives at the second coating apparatus 6, which is followed by being roll-wrapped by the roll-wrapping apparatus 7.

It should be noted that the tension-controlling roller set 2 is capable of controlling the tension it applies to the fiber prepreg material (B), so as to further control a coefficient of variation of numbers of fiber breakage occurring due to puncturing in the region of the fiber prepreg material (B) to be not greater than 0.5%. In addition, the needle seats 413 do not necessarily have to be filled with the needles 43. The number and position of the needles 43 shown in FIG. 2 are merely for illustration. In fact, the number and density of the needles 43 may be adjusted according to actual needs. That is to say, distances between the needles 43 and positions thereof may be arranged, so that the configuration flexibility of the puncture apparatus 4 may be enhanced, and the disassembly and repair of the puncture apparatus 4 may also be facilitated. After puncturing the fiber prepreg material (B), each of the needles 43 is to be inserted into a respective one of the second holes 421 of the base plate 42. The second holes 421 affect the puncture depth of the needles 43, and have the function of collecting dust generated during puncturing.

In sum, the fiber prepreg material (B), after being punctured by the above method to form the perforations thereon, has a higher ductility, thereby making it easy to be roll-wrapped, and has an improved mechanical properties. Moreover, the perforations may help to discharge air, thereby solving the problem of entrapped air voids, which tend to be present during coiling and packaging. Furthermore, the puncture equipment and the method according to the disclosure are applicable to a conventional impregnating system without the need for secondary processing, thereby improving operation efficiency and providing high versatility. Thus, the object of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A puncture equipment for puncturing a fiber prepreg material, comprising:
a feeding roller set adapted to deliver the fiber prepreg material along a feeding direction;
a tension-controlling roller set located downstream of said feeding roller set, said tension-controlling roller set being adapted to impart tension to the fiber prepreg material and to continuously deliver the fiber prepreg material along said feeding direction;
a puncture apparatus located downstream of said tension-controlling roller set, said puncture apparatus including a needle-carrying plate, a base plate that is oppositely located to said needle-carrying plate relative to the fiber prepreg material, and a plurality of needles that are detachably disposed on said needle-carrying plate, said needle-carrying plate being capable of moving toward said base plate, said needles having a number less than 6225, any two adjacent ones of said needles being spaced apart by a distance ranging from 15 millimeters to 1000 millimeters; and
a roll-wrapping apparatus located downstream of said puncture apparatus and adapted to roll wrap the fiber prepreg material.

2. The puncture equipment as claimed in claim 1, wherein said needle-carrying plate of said puncture apparatus includes a plate body having a plurality of first holes, and a plurality of needle seats disposed on said plate body, each of said needle seats being registered with a respective one of said first holes, said needles being respectively inserted into said needle seats, said base plate having a plurality of second holes which are respectively registered with said needle seats of said needle-carrying plate.

3. The puncture equipment as claimed in claim 2, wherein said first holes include through holes.

4. The puncture equipment as claimed in claim 2, wherein said second holes include through holes.

5. The puncture equipment as claimed in claim 1, further comprising a first coating apparatus located downstream of said puncture apparatus and upstream of said roll-wrapping apparatus, and adapted to coat a film on the fiber prepreg material.

6. The puncture equipment as claimed in claim 5, further comprising a second coating apparatus located downstream of said first coating apparatus and upstream of said roll-wrapping apparatus, and adapted to coat a release paper on the fiber prepreg material.

7. The puncture equipment as claimed in claim 6, further comprising a driving roller set located downstream of said tension-controlling roller set and upstream of said puncture apparatus, said driving roller set being adapted to assist delivery of the fiber prepreg material along said feeding direction.

8. A method for puncturing a fiber prepreg material, comprising:
delivering the fiber prepreg material along a feeding direction and imparting tension thereto; and
puncturing the fiber prepreg material, so as to form a plurality of perforations in a region of the fiber prepreg material, the perforations in the region of the fiber prepreg material having a number less than 6225, the region of the fiber prepreg material having long fibers and short fibers that are in a number ratio of 65.2 to 34.8, a fiber length between any two adjacent ones of the perforations in the region of the fiber prepreg material ranging from 15 millimeters to 1000 millimeters.

9. A method for puncturing a fiber prepreg material, comprising:
delivering the fiber prepreg material along a feeding direction and imparting tension thereto; and
puncturing the fiber prepreg material, so as to form a plurality of perforations in a region of the fiber prepreg material, the perforations in the region of the fiber prepreg material having a number less than 6225, the region of the fiber prepreg material having long fibers and short fibers that are in a number ratio of 65.2 to 34.8, a fiber length between any two adjacent ones of the perforations in the region of the fiber prepreg material ranging from 15 millimeters to 1000 millimeters,
wherein the method is conducted utilizing a puncture equipment as claimed in claim 1.
